(19) United States
(12) Patent Application Publication
(10) Pub. No.: US 2025/0206082 A1
(43) Pub. Date: Jun. 26, 2025

(54) STORAGE BODY WITH FUNCTIONAL COMPONENT AND TIRE

(71) Applicant: THE YOKOHAMA RUBBER CO., LTD., Kanagawa (JP)

(72) Inventor: Masahiro NARUSE, Kanagawa (JP)

(21) Appl. No.: 18/848,358

(22) PCT Filed: Dec. 23, 2022
(86) PCT No.: PCT/JP2022/047511

§ 371 Date: Sep. 18, 2024

(30) Foreign Application Priority Data
Mar. 23, 2022 (JP) 2022-047067

(51) Int. Cl. B60C 23/04

(52) U.S. Cl. CPC B60C 23/0493

(57) ABSTRACT

A functional component to acquire tire information is housed by a housing body. The housing body includes a bottom portion fixed to a tire inner surface, a crown portion protruding from the bottom portion, a housing space formed by the bottom portion and the crown portion, and an opening portion communicating with the housing space. The opening portion has a width smaller than a minimum width of the housing space. A circumferential length (D2ᵤ) of an upper portion of the housing space and a circumferential length (D1ᵤ) of an upper portion of the functional component satisfy a relationship 0.60≤D2ᵤ/D1ᵤ≤0.95.

### TECHNICAL FIELD

The present technology relates to a housing body with a functional component and a tire and particularly relates to a housing body with a functional component and a tire that can prevent damage of the housing body housing the functional component while providing improved high-speed durability of the functional component by devising a dimensional relationship between the housing body and the functional component.

### BACKGROUND ART

A functional component (for example, a sensor unit including a sensor) configured to acquire tire internal information such as internal pressure or temperature is installed on a tire inner surface (see, for example, Japan Patent No. 6272225 B and Japan Unexamined Patent Publication No. 2016-505438 T). In installing the functional component, a housing body (container) made of rubber or the like is adhered to the tire inner surface, and the functional component is housed inside the adhered housing body. Unfortunately, when the functional component is not sufficiently restrained by the housing body in housing the functional component in the housing body, for example, when the outer circumferential length of the functional component is equivalent to or smaller than the inner circumferential length of the housing body, the movement of the functional component increases during high-speed travel, and heat generation increases due to friction between the housing body and the functional component, causing a housing of the functional component to be damaged.

### SUMMARY

The present technology provides a housing body with a functional component and a tire that can prevent damage of the housing body housing the functional component while providing improved high-speed durability of the functional component by devising a dimensional relationship between the housing body and the functional component.

A housing body with a functional component according to an embodiment of the present technology is a housing body with a functional component including a functional component configured to acquire tire information and a housing body housing the functional component. The housing body includes a bottom portion fixed to a tire inner surface, a crown portion protruding from the bottom portion, a housing space formed by the bottom portion and the crown portion, and an opening portion communicating with the housing space. The opening portion has a width smaller than a minimum width of the housing space. A circumferential length D2ᵤ of an upper portion of the housing space and a circumferential length D1ᵤ of an upper portion of the functional component satisfy a relationship 0.60≤D2ᵤ/D1ᵤ≤0.95.

A tire according to an embodiment of the present technology includes the aforementioned housing body with a functional component fixed to the tire inner surface, and the functional component is housed in the housing space.

According to an embodiment of the present technology, the housing body with a functional component includes the functional component configured to acquire tire information and the housing body housing the functional component, the housing body includes the bottom portion fixed to the tire inner surface, the crown portion protruding from the bottom portion, the housing space formed by the bottom portion and the crown portion, and the opening portion communicating with the housing space, the opening portion has the width smaller than the minimum width of the housing space, and the circumferential length D2ᵤ of the upper portion of the housing space and the circumferential length D1ᵤ of the upper portion of the functional component satisfy the relationship 0.60≤D2ᵤ/D1ᵤ≤0.95. This can increase restricting force of the housing body with respect to the functional component and suppress the motion of the functional component, thus allowing damage of a housing of the functional component during high-speed travel to be prevented. In addition, a good balance between the restricting force of the housing body with respect to the functional component and the degree of deformation at which the housing body is not damaged is provided, thus allowing damage of the housing body to be also prevented. This can prevent the damage of the housing body while providing improved high-speed durability of the functional component.

In a housing body with a functional component according to an embodiment of the present technology, a ratio D2ᵤ/D1ᵤ of the circumferential length D2ᵤ of the upper portion of the housing space to the circumferential length D1ᵤ of the upper portion of the functional component is preferably equivalent to or smaller than a ratio D2_{L}/D1_{L} of a circumferential length D2_{L} of a lower portion of the housing space to a circumferential length D1_{L} of a lower portion of the functional component. This makes the restricting force by the housing body higher at the upper portion than at the lower portion, thus allowing a load applied to the base of the housing body to be reduced and durability of the housing body to be improved.

An end portion of the crown portion preferably includes a locking portion bent toward the opening portion, and a height H1 of the functional component and a total inner height H2 of the housing body preferably satisfy a relationship 0.85≤H2/H1≤0.98. This provides a good balance between the restricting force of the housing body with respect to the functional component and the degree of deformation at which the housing body is not damaged and can improve the durability of the functional component during high-speed travel.

A circumferential length D2_{O} of the opening portion of the housing body and the circumferential length D1ᵤ of the upper portion of the functional component preferably satisfy a relationship 0.4≤D2_{O}/D1ᵤ≤0.8. This provides a good balance between the restricting force of the housing body with respect to the functional component and the degree of deformation at which the housing body is not damaged and can improve the durability of the functional component during high-speed travel. Additionally, the opening portion of the housing body is not excessively narrow, which is suitable for removing the functional component.

A sum Sc of cross-sectional areas of the housing space and the opening portion in a state where the functional component is not housed in the housing space and a cross-sectional area Ss of the functional component in the sum Sc of the cross-sectional areas of the housing space and the opening portion preferably satisfy a relationship 0.6≤Sc/Ss≤0.9. This can increase the restricting force of the housing body with respect to the functional component and suppress the motion of the functional component, thus allowing the high-speed durability of the functional component to be improved and the occurrence of cracks in the housing body to be prevented.

An inclination angle of the crown portion measured on an outer wall side of the crown portion in a state where the functional component is housed in the housing space with respect to the bottom portion preferably ranges from 90° to 115°. This can mitigate stress concentration at the base of the crown portion of the housing body and improve the durability of the housing body. Additionally, the opening portion of the housing body is not excessively narrow, which is suitable for removing the functional component.

A modulus of the housing body at 100% elongation at 20° C. is preferably 0.5 MPa or more and less than 10.0 MPa, and a loss modulus of the housing body at 60° C. is preferably 0.4 MPa or more and less than 20.0 MPa. Appropriately setting the modulus as just described can provide the durability of the housing body and ease of housing the functional component in the housing body in a compatible manner. Appropriately setting the loss modulus as just described can prevent damage of the housing of the functional component due to rubbing of the functional component against the housing body or repeated deformation of the housing body.

The housing body is preferably made of vulcanized rubber. The housing body is preferably fixed to the tire inner surface with an adhesive.

The tire according to an embodiment of the present technology is preferably a pneumatic tire but may be a non-pneumatic tire. In a case of a pneumatic tire, the interior thereof can be filled with any gas including air and inert gas such as nitrogen.

### BRIEF DESCRIPTION OF DRAWINGS

FIGS. 1A to 1D illustrate an embodiment of a housing body with a functional component before and after the functional component is housed. FIG. 1A is a perspective view illustrating a state where the functional component is not housed, FIG. 1B is a cross-sectional view illustrating a state where the functional component is not housed, FIG. 1C is a perspective view illustrating a state where the functional component is housed, and FIG. 1D is a cross-sectional view illustrating a state where the functional component is housed.

FIG. 2 is a half cross-sectional view of the housing body for describing the dimensions of the housing body in a state where the functional component is not housed.

FIGS. 3A and 3B are half cross-sectional views of the housing body with a functional component for describing the dimensions of the housing body in a state where the functional component is housed.

FIGS. 4A and 4B are views for describing cross-sectional areas of the housing body and the functional component, in which FIG. 4A is an explanatory diagram of the housing body, and FIG. 4B is an explanatory diagram of the functional component.

FIG. 5 is a meridian cross-sectional view illustrating an embodiment of a pneumatic tire in which the housing body with a functional component is fixed to a tire inner surface.

FIG. 6 is an enlarged cross-sectional view illustrating the housing body with a functional component of FIG. 5.

### DETAILED DESCRIPTION

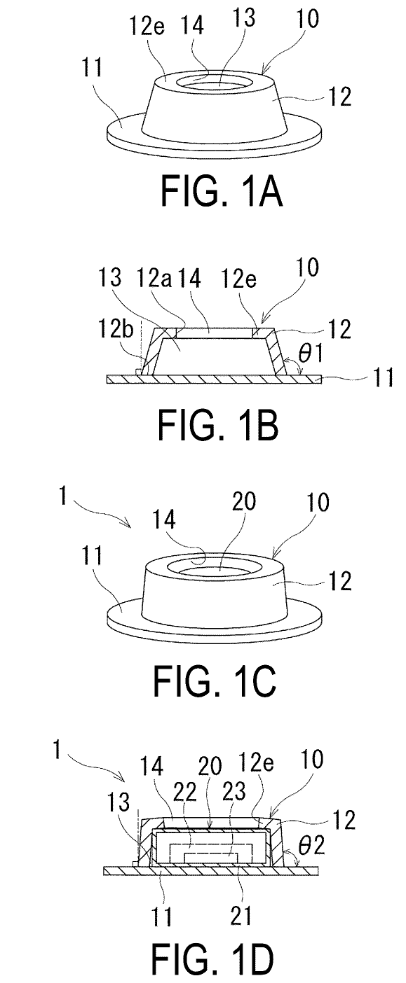

Hereinafter, embodiments of a housing body with a functional component of the present technology will be described in detail with reference to the accompanying drawings. A housing body with a functional component 1 illustrated in FIGS. TA to 1D includes a functional component 20 configured to acquire tire information and a housing body 10 housing the functional component 20. The housing body with a functional component 1 in FIGS. 1A and 1B is in a state where the functional component 20 is not housed in the housing body 10, and the housing body with a functional component 1 in FIGS. 1C and 1D is in a state where the functional component 20 is housed in the housing body 10.

The housing body 10 includes a flat plate-shaped bottom portion 11 fixed to the tire inner surface, a cylindrical crown portion 12 protruding from the bottom portion 11, a housing space 13 formed by the bottom portion 11 and the crown portion 12, and an opening portion 14 communicating with the housing space 13.

The bottom portion 11 is the longest (and has the maximum diameter) among the portions constituting the housing body 10. The crown portion 12 is formed to be inclined inward from a direction orthogonal to the bottom portion 11. Accordingly, the housing space 13 formed by the bottom portion 11 and the crown portion 12 has a substantially trapezoidal cross-sectional shape. In other words, the cross-sectional width of the housing space 13 gradually decreases toward an upper portion and becomes smallest at the maximum height position. The crown portion 12 includes a locking portion 12e formed at one end 12a so as to be bent toward the opening portion 14, and the other end 12b is fixed to the bottom portion 11. After the functional component 20 is housed, the locking portion 12e is brought into contact with an upper surface of the functional component 20 and serves to fix the functional component 20 when the functional component 20 is housed. The width of the opening portion 14 into which the functional component 20 is inserted is smaller than the minimum width of the housing space 13 in a cross-sectional view (the width at a position adjacent to the opening portion 14).

In FIGS. 1A to 1D, each of the bottom portion 11, the crown portion 12, and the opening portion 14 has a circular planar shape and the housing space 13 has a truncated cone shape. The planar shapes of the bottom portion 11, the crown portion 12, and the opening portion 14 are not limited to a particular shape and may be any other planar shape or may be planar shapes different from each other. The shape of the housing space 13 is not limited to a particular shape, either.

As illustrated in FIG. 1D, the functional component 20 includes a housing 21 and an electronic component 22. The housing 21 has a hollow structure, and the electronic component 22 is housed therein. The electronic component 22 can include a sensor 23 configured to acquire tire information, a transmitter, a receiver, a control circuit, and a battery as appropriate. Examples of the tire information acquired by the sensor 23 include an internal temperature and an internal pressure of a pneumatic tire and the amount of wear of a tread portion. For example, a temperature sensor or a pressure sensor is used to measure internal temperature or internal pressure. In a case where the amount of wear of the tread portion is detected, a piezoelectric sensor including a piezoelectric element can be used as the sensor 23, and the piezoelectric element detects an output voltage corresponding to tire deformation during travel and detects the amount of wear of the tread portion in accordance with the output voltage. Moreover, an acceleration sensor or a magnetic sensor can also be used. The functional component 20 is configured to transmit the tire information acquired by the sensor 23 to the outside of the tire. Furthermore, to easily hold the functional component 20, a knob portion protruding from an upper surface of the housing 21 may be provided, and the knob portion can have a function of an antenna.

The internal structure of the functional component 20 illustrated in FIG. 1D is an example, and the internal structure is not limited to thereto. The sensor 23 may be fixed to the housing body 10 with an adhesive tape, an adhesive, or the like, or may not be fixed to the housing body 10.

In such a housing body with a functional component 1, a circumferential length D2ᵤ of the upper portion of the housing space 13 and a circumferential length D1ᵤ of an upper portion of the functional component 20 are configured to satisfy the relationship 0.60≤D2ᵤ/D1ᵤ≤0.95. In other words, the circumferential length D2ᵤ of the housing space 13 is set to be smaller than the circumferential length D1ᵤ of the functional component 20 within a specific range, and it is thereby intended to increase restricting force by the housing body 10. Here, as illustrated in FIG. 2, the circumferential length D2ᵤ of the housing space 13 is obtained by defining a height of three quarters of a total inner height H2 (0.75×H2) of the housing body 10 as h2 before the functional component 20 is housed, measuring the circumferential length of the housing space 13 at a total of three positions including the position of the height h2 and the positions corresponding to +25% of the height h2 (0.25×h2) with reference to the position of the height h2, and averaging the circumferential lengths measured at these three positions. The circumferential length D1ᵤ of the upper portion of the functional component 20 is obtained by measuring the circumferential length of the functional component 20 at positions corresponding to the aforementioned three positions of the functional component 20 and averaging the circumferential lengths measured at these three positions. The total inner height H2 of the housing body 10 is a height from an upper surface of the bottom portion 11 to a lower surface of the locking portion 12e before the functional component 20 is housed.

The aforementioned housing body with a functional component includes the functional component 20 configured to acquire tire information and the housing body 10 housing the functional component 20, the housing body 10 includes the bottom portion 11 fixed to the tire inner surface, the crown portion 12 protruding from the bottom portion 11, the housing space 13 formed by the bottom portion 11 and the crown portion 12, and the opening portion 14 communicating with the housing space 13, the opening portion 14 has a width narrower than the minimum width of the housing space 13, and the circumferential length D2ᵤ of the upper portion of the housing space 13 and the circumferential length D1ᵤ of the upper portion of the functional component 20 satisfy the relationship 0.60≤D2ᵤ/D1ᵤ≤0.95. This can increase restricting force of the housing body 10 with respect to the functional component 20 and suppress the motion of the functional component 20, thus allowing damage of the housing 21 of the functional component 20 during high-speed travel to be prevented. In addition, a good balance between the restricting force of the housing body 10 with respect to the functional component 20 and the degree of deformation at which the housing body 10 is not damaged is provided, and thus damage of the housing body 10 can also be prevented. This can prevent the damage of the housing body 10 while providing improved high-speed durability of the functional component 20.

Here, when the ratio D2ᵤ/D1ᵤ is less than 0.60, the degree of deformation of the crown portion 12 also increases though the restricting force by the housing body 10 increases. As a result, cracks are generated in the housing body 10 during long-distance travel, and the possibility of damage of the housing body 10 increases. On the other hand, when the ratio D2ᵤ/D1ᵤ is larger than 0.95, the restricting force by the housing body 10 decreases, and the motion of the functional component 20 in the housing body 10 increases. This increases heat generation due to friction between the housing body 10 and the functional component 20, resulting in damage of the housing 21 of the functional component 20.

In the aforementioned housing body with a functional component, the ratio D2ᵤ/D1ᵤ of the circumferential length D2ᵤ of the upper portion of the housing space 13 to the circumferential length D1ᵤ of the upper portion of the functional component 20 is preferably equivalent to or smaller than the ratio D2_{L}/D1_{L} of a circumferential length D2_{L} of a lower portion of the housing space 13 to a circumferential length D1_{L} of a lower portion of the functional component 20. In other words, it is intended to increase the restricting force by the housing body 10 more at the upper portion than at the lower portion by setting the ratio D2ᵤ/D1ᵤ of the upper portion to be equivalent to or smaller than the ratio D2_{L}/D1_{L} of the lower portion. Here, as illustrated in FIG. 2, the circumferential length D2_{L} of the lower portion of the housing space 13 is obtained by defining a height of one quarter of the total inner height H2 (0.25×H2) of the housing body 10 as h2′ before the functional component 20 is housed, measuring the circumferential length of the housing space 13 at a total of three positions including the position of the height h2′ and the positions corresponding to ±25% of the height h2′ (0.25×h2′) with reference to the position of the height h2′, and averaging the circumferential lengths measured at these three positions. The circumferential length D1_{L} of the lower portion of the functional component 20 is obtained by measuring the circumferential length of the functional component 20 at positions corresponding to the aforementioned three positions of the functional component 20 and averaging the circumferential lengths measured at these three positions.

Appropriately setting the relationship between the ratio D2ᵤ/D1ᵤ and the ratio D2_{L}/D1_{L} as just described makes the restricting force by the housing body 10 higher at the upper portion than at the lower portion, thus allowing a load applied to the base of the housing body 10 to be reduced and durability of the housing body 10 to be improved. Here, when the ratio D2ᵤ/D1ᵤ of the upper portion is larger than the ratio D2_{L}/D1_{L} of the lower portion, the restricting force by the housing body 10 is high at the lower portion. As a result, a load is applied to the base of the housing body 10, and the housing body 10 is likely to be damaged during long-distance travel.

Further, a circumferential length D2_{O} of the opening portion 14 of the housing body 10 and the circumferential length D1ᵤ of the upper portion of the functional component 20 preferably satisfy the relationship 0.4≤D2_{O}/D1ᵤ≤0.8. Here, the circumferential length D2_{O} of the opening portion 14 is a circumferential length of the opening portion 14 measured in a state where the functional component 20 is not housed in the housing body 10. Appropriately setting the circumferential length D2_{O} of the opening portion 14 and the circumferential length D1ᵤ of the functional component 20 as just described provides a good balance between the restricting force of the housing body 10 with respect to the functional component 20 and the degree of deformation at which the housing body 10 is not damaged and can improve durability of the functional component 20 during high-speed travel. Furthermore, the opening portion 14 of the housing body 10 is not excessively narrow, which is suitable for removing the functional component 20.

Here, when the ratio D2_{O}/D1ᵤ is less than 0.4, the opening portion 14 is excessively narrow, and thus it becomes difficult to remove the functional component 20. On the other hand, when the ratio D2_{O}/D1ᵤ is larger than 0.8, the restricting force by the housing body 10 decreases, and the motion of the functional component 20 in the housing body 10 increases. This increases heat generation due to friction between the housing body 10 and the functional component 20, resulting in damage of the housing 21 of the functional component 20.

In the aforementioned housing body with a functional component, an inclination angle θ2 (see FIG. 1D) of the crown portion 12 with respect to the bottom portion 11 in a state where the functional component 20 is housed in the housing space 13 is preferably smaller than an inclination angle θ1 (see FIG. 1B) of the crown portion 12 with respect to the bottom portion 11 in a state where the functional component 20 is not housed in the housing space 13. Each of the inclination angles θ1 and θ2 is an angle measured on the outer wall side of the crown portion 12. When the functional component 20 is housed in the housing space 13 from the opening portion 14, the crown portion 12 flexes toward the outer side and deforms so as to expand the width of the opening portion 14, and thus the inclination angle θ of the crown portion 12 with respect to the bottom portion 11 decreases. In particular, the angle difference (01-02) between the inclination angle θ1 before the functional component 20 is housed and the inclination angle θ2 after the functional component 20 is housed is preferably in the range of 5° to 15°.

As described above, the inclination angle θ2 of the crown portion 12 after the functional component 20 is housed is smaller than the inclination angle θ1 of the crown portion 12 before the functional component 20 is housed, and thus excessive deformation of the housing body 10 can be prevented while the restricting force by which the functional component 20 can be sufficiently restricted is ensured in the housing body 10 housing the functional component 20. In particular, when the angle difference (01-02) between the inclination angles before and after the functional component 20 is housed is in the range of 5° to 15°, the restricting force of the housing body 10 with respect to the functional component 20 and the degree of deformation at which the housing body 10 is not damaged is extremely well-balanced. This can prevent damage of the housing body 10 while preventing the functional component 20 from coming off during travel.

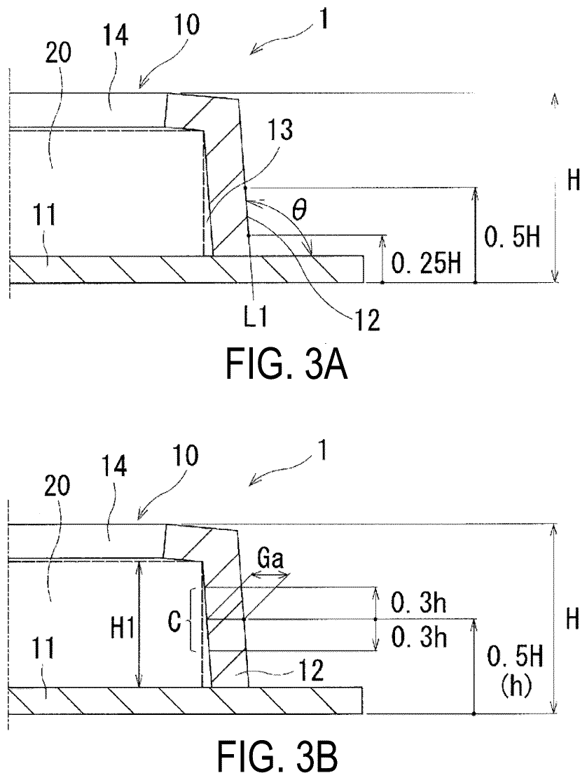

Here, in measuring the inclination angle θ (01, 02) of the crown portion 12, the angle can be calculated by using a CT scan or the like. Only in measuring the inclination angle θ of the crown portion 12, as illustrated in FIG. 3A, the inclination angle θ1 before the functional component 20 is housed and the inclination angle θ2 after the functional component 20 is housed are measured by regarding, as the crown portion 12, a straight line L1 passing through two points, one half of a total height H (0.5×H) and one quarter of the total height H (0.25×H) of the housing body 10 on the outer surface of the crown portion 12. The total height H (maximum height H) of the housing body 10 changes before and after the functional component 20 is housed, and the inclination angle θ (01, 02) of the crown portion 12 is measured based on each height. When a projection is formed on the outer surface of the crown portion 12 at the position corresponding to one half and/or one quarter of the total height H of the housing body 10, the inclination angle θ of the crown portion 12 is measured based on a straight line defined by using a lower end portion of the projection as a new reference point without including the projection. The total height H of the housing body 10 is a height from a lower surface of the bottom portion 11 to an upper surface of the locking portion 12e.

Here, when the angle difference (01-02) of the inclination angles is smaller than 5°, the restricting force of the housing body 10 with respect to the functional component 20 is reduced. As a result, the risk of coming-off of the functional component 20 during travel increases and the motion of the functional component 20 increases, and thus the durability of the housing body 10 is reduced. On the other hand, when the angle difference (01-02) between the inclination angles is larger than 15°, the deformation of the housing body 10 becomes excessively large, and cracks are likely to occur in the housing body 10 during long-distance travel.

In particular, the inclination angle θ2 of the crown portion 12 with respect to the bottom portion 11 in a state where the functional component 20 is housed in the housing space 13 is preferably 900 or more and more preferably in the range of 90° to 115°. Appropriately setting the inclination angle θ2 after the functional component 20 is housed as just described can mitigate stress concentration at the base of the crown portion 12 of the housing body 10 and improve the durability of the housing body 10. Moreover, the opening portion 14 of the housing body 10 is not excessively narrow, which is suitable for removing the functional component 20.

Here, when the inclination angle θ2 after the functional component 20 is housed is smaller than 90°, stress concentration at the base of the crown portion 12 of the housing body 10 increases, and strain energy during travel increases. As a result, cracks are likely to occur at the base of the crown portion 12. On the other hand, when the inclination angle θ2 after the functional component 20 is housed is larger than 115°, the crown portion 12 is excessively flexed even after the functional component 20 is housed. This makes the width of the opening portion 14 excessively narrow and makes it difficult to remove the functional component 20.

In a state where the functional component 20 is housed in the housing space 13, the crown portion 12 preferably has a thickness Ga of 1.0 mm to 3.5 mm. Here, as illustrated in FIG. 3B, a half height of the total height H of the housing body 10 after the functional component 20 is housed is h, and the range of 30% of the height h (0.3×h) with reference to the position (center position) of the height h is a central range C. At this time, in the entire central range C, the thickness Ga of the crown portion 12 measured in a horizontal direction is preferably in the range of 1.0 mm to 3.5 mm.

Appropriately setting the thickness Ga of the crown portion 12 as just described can suppress the occurrence of cracks in the crown portion 12 of the housing body 10 and improve the durability of the housing body 10. Furthermore, when the thickness Ga of the crown portion 12 of the housing body 10 is excessively large, the heat generation of the housing body 10 increases. However, when the thickness Ga is within the range described above, the heat generation of the housing body 10 can be suppressed, and damage of the housing 21 of the functional component 20 can be prevented.

Here, when the thickness Ga of the crown portion 12 is less than 1.0 mm, the thickness Ga of the crown portion 12 is excessively small, and cracks are likely to occur in the crown portion 12. On the other hand, when the thickness Ga of the crown portion 12 is larger than 3.5 mm, the heat generation of the housing body 10 (for example, rubber) increases, and the housing 21 of the functional component 20 is likely to be damaged.

The end 12a of the crown portion 12 preferably includes the locking portion 12e bent toward the opening portion 14, and the height H1 of the functional component 20 and the total inner height H2 of the housing body 10 preferably satisfy the relationship 0.85≤H2/H1≤0.98. Here, as illustrated in FIG. 3B, the height H1 of the functional component 20 is the maximum height within a range in which the functional component 20 is housed in the housing body 10 after the functional component 20 is housed, that is, the maximum height of the functional component 20 in the housing space 13. This means that when, for example, a knob portion disposed on an upper portion of the functional component 20 protrudes from the housing space 13, the height H1 of the functional component 20 does not include the height of a portion of the knob portion outside the housing space 13.

Appropriately setting the height H1 of the functional component 20 and the total inner height H2 of the housing body 10 as just described provides a good balance between the restricting force of the housing body 10 with respect to the functional component 20 and the degree of deformation at which the housing body 10 is not damaged and can improve the durability of the functional component 20 during high-speed travel.

Here, when the ratio H2/H1 is less than 0.85, the locking portion 12e cannot house the functional component 20 so as to cover the functional component 20, and thus the effect of improving the durability of the functional component 20 during high-speed travel is reduced. On the other hand, when the ratio H2/H1 is larger than 0.98, the restricting force of the housing body 10 decreases, and the motion of the functional component 20 in the housing body 10 increases. As a result, the effect of improving the durability of the functional component 20 during high-speed travel cannot be obtained.

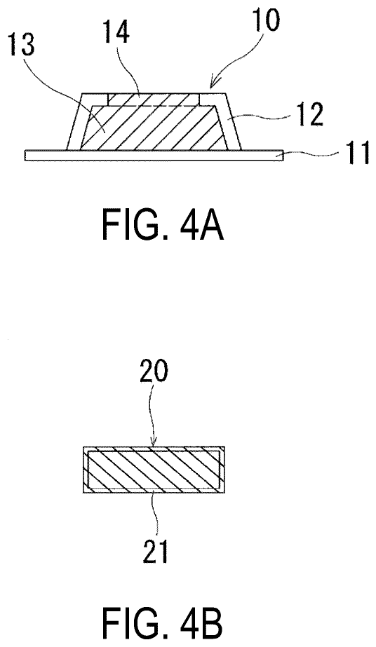

The sum Sc of the cross-sectional areas of the housing space 13 and the opening portion 14 in a state where the functional component 20 is not housed in the housing space 13 and the cross-sectional area Ss of the functional component 20 in the sum Sc of the cross-sectional areas of the housing space 13 and the opening portion 14 satisfy the relationship 0.6≤Sc/Ss≤0.9. Specifically, the sum Sc of the cross-sectional areas of the housing body 10 is the total area of the cross-sectional area of the housing space 13 and the cross-sectional area of the opening portion 14 and corresponds to the area of the shaded portion in FIG. 4A. The cross-sectional area Ss of the functional component 20 is the cross-sectional area of the functional component 20 and corresponds to the area of the shaded portion in FIG. 4B. The sum Sc of the cross-sectional areas of the housing body 10 and the cross-sectional area Ss of the functional component 20 can be calculated by photographing the housing body 10 and the functional component 20 by using a CT scan or the like. For example, when a knob portion disposed on the upper portion of the functional component 20 protrudes from the opening portion 14, the cross-sectional area Ss of the functional component 20 does not include the cross-sectional area of a portion of the knob portion protruding from the opening portion 14.

Appropriately setting the ratio Sc/Ss of the sum Sc of the cross-sectional areas of the housing body 10 to the cross-sectional area Ss of the functional component 20 as just described can increase the restricting force of the housing body 10 with respect to the functional component 20 and suppress the motion of the functional component 20, thus allowing the high-speed durability of the functional component 20 to be improved and the occurrence of cracks in the housing body 10 to be prevented.

Here, when the ratio Sc/Ss is less than 0.6, the restricting force of the housing body 10 with respect to the functional component 20 increases, and the high-speed durability of the functional component 20 is improved. However, the restricting force by the housing body 10 is excessively strong, and thus the amount of deformation of the housing body 10 is large, and cracks are likely to occur in the housing body 10 during long-distance travel. On the other hand, when the ratio Sc/Ss is larger than 0.9, the restricting force of the housing body 10 with respect to the functional component 20 cannot be sufficiently obtained, and the effect of improving the durability of the functional component 20 during high-speed travel cannot be obtained.

In the aforementioned housing body with a functional component, the housing body 10 can be made of rubber, elastomer, resin, or the like. The constituent material of the housing body 10 preferably has the following physical properties. The modulus of the housing body 10 at 100% elongation at 20° C. is preferably 0.5 MPa or more and less than 10.0 MPa, and the loss modulus of the housing body 10 at 60° C. is preferably 0.4 MPa or more and less than 20.0 MPa. Appropriately setting the modulus as just described can provide the durability of the housing body 10 and ease of housing the functional component 20 in the housing body 10 in a compatible manner. Appropriately setting the loss modulus as just described can prevent damage of the housing 21 of the functional component 20 due to rubbing of the functional component 20 against the housing body 10 or repeated deformation of the housing body 10.

Furthermore, the constituent material of the housing body 10 more preferably has the following physical properties. The elongation at break measured in accordance with JIS (Japanese Industrial Standard) K6251 is preferably 80% to 800% at 20° C. The tan 6 measured in accordance with JIS K6394 is preferably 0.04 to 0.40 at 60° C.

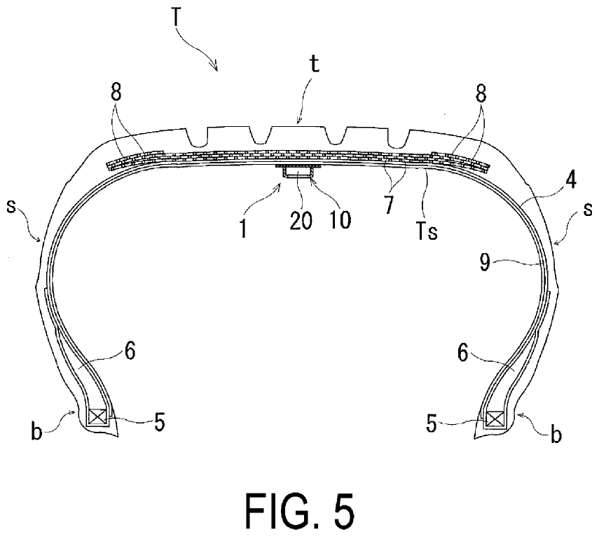

FIG. 5 illustrates a pneumatic tire in which the housing body with a functional component is fixed to the tire inner surface. As illustrated in FIG. 5, a pneumatic tire T includes a tread portion t extending in the tire circumferential direction and having an annular shape, a pair of sidewall portions s disposed on both sides of the tread portion t, and a pair of bead portions b each disposed on an inner side in the tire radial direction of the sidewall portions s.

A carcass layer 4 is mounted between the pair of bead portions b. The carcass layer 4 includes a plurality of reinforcing cords extending in the tire radial direction and is folded back around a bead core 5 disposed in each of the bead portions b from a tire inner side to a tire outer side. A bead filler 6 having a triangular cross-sectional shape and formed of a rubber composition is disposed on the outer circumference of the bead core 5. In addition, an innerliner layer 9 is disposed in an area between the pair of bead portions b on a tire inner surface Ts. The innerliner layer 9 forms the tire inner surface Ts.

Meanwhile, a plurality of belt layers 7 are embedded on the outer circumferential side of the carcass layer 4 in the tread portion t. The belt layers 7 include a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set to fall in a range from 10° to 40°, for example. Steel cords are preferably used as the reinforcing cords of the belt layers 7. To improve high-speed durability, at least one belt cover layer 8 formed by arranging reinforcing cords at an angle of, for example, 5° or less with respect to the tire circumferential direction is disposed on an outer circumferential side of the belt layers 7. Organic fiber cords such as nylon and aramid are preferably used as the reinforcing cords of the belt cover layer 8.

Note that the tire internal structure described above represents a typical example of a pneumatic tire, but the pneumatic tire is not limited thereto.

In the pneumatic tire described above, at least one housing body with a functional component 1 is attached to the tire inner surface Ts. The housing body with a functional component 1 is fixed to the tire inner surface Ts with an adhesive. The adhesive preferably has a storage modulus at −40° C. in the range of 5.0×10⁸ Pa to 1.0×10¹⁰ Pa and a storage modulus at 150° C. in the range of 1.0×10⁶ Pa to 5.0×10⁷ Pa. Examples of the adhesive having such physical properties include instantaneous adhesives, epoxy-based adhesives, acrylic-based adhesives, rubber-based adhesives, and urethane-based adhesives. Appropriately setting the storage modulus of the adhesive as just described can prevent the housing body 10 from coming off due to repeated deformation or applied load applied during travel of the tire. The durability of the housing body 10 can be sufficiently ensured even when heat is generated during travel.

The housing body with a functional component 1 can be attached to any portion of the tire inner surface Ts. However, the housing body with a functional component 1 is preferably attached to the tire inner surface Ts corresponding, in particular, to the tread portion t of the tread portion t, the sidewall portions s, and the bead portions b because the housing body with a functional component 1 is less deformed during travel and is unlikely to come off due to centrifugal force applied thereto.

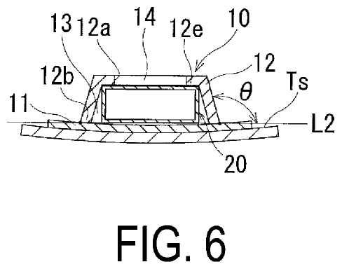

Here, as illustrated in FIG. 6, when the inclination angles θ1 and θ2 are measured in a state where the housing body with a functional component 1 is fixed to the tire inner surface, an angle formed by a straight line L2 passing through the other end 12b of both sides of the crown portion 12 in a cross-sectional view and the crown portion 12 is measured. For example, even a housing body with a functional component that is not provided with a member corresponding to a bottom portion and is provided with a crown portion directly fixed to the tire inner surface can be measured by the same method as described above.

In the aforementioned embodiment, an example in which the housing body with a functional component is attached to the pneumatic tire is described but no such limitation is intended, and the housing body with a functional component can be applied to a non-pneumatic tire.

### Examples

Tires of Conventional Examples 1 and 2 and Examples 1 to 24 were manufactured. Each of the tires has a tire size of 225/45ZR18 and includes a functional component configured to acquire tire information and a housing body housing the functional component. The housing body includes a bottom portion fixed to the tire inner surface, a crown portion protruding from the bottom portion, a housing space formed by the bottom portion and the crown portion, and an opening portion communicating with the housing space. The opening portion has a width smaller than the minimum width of the housing space. A housing body with a functional component in which the functional component is housed in the housing body is fixed to the tire inner surface. The ratio D2ᵤ/D1ᵤ, the magnitude relationship between the ratio D2ᵤ/D1ᵤ and the ratio D2_{L}/D1_{L}, the ratio H2/H1, the ratio D2_{O}/D1ᵤ, the ratio Sc/Ss, and the inclination angle θ2 of the crown portion after housing were set as indicated in Tables 1 and 2.

In Tables 1 and 2, regarding the “magnitude relationship between the ratio D2ᵤ/D1ᵤ and the ratio D2_{L}/D1_{L}, when the ratio D2ᵤ/D1ᵤ is larger than the ratio D2_{L}/D1_{L}, it is indicated as “larger,” when the ratio D2ᵤ/D1ᵤ is equivalent to the ratio D2_{L}/D1_{L}, it is indicated as “equivalent,” and when the ratio D2ᵤ/D1ᵤ is smaller than the ratio D2_{L}/D1_{L}, it is indicated as “smaller”.

The high-speed durability and removability in the functional component were evaluated for the test tires by the following test methods, and the cracking resistance and durability of the housing body were evaluated. The results are also indicated in Tables 1 and 2.

### High-Speed Durability (Functional Component):

Each of the test tires was mounted on a wheel having a rim size of 18×7½JJ, an 88% load of the maximum load capacity was applied, and a running test was performed on the tire using a drum testing machine under the condition of air pressure of 360 kPa. Specifically, the speed was increased from an initial speed of 120 km/h by 10 km/h every ten minutes, the tires were run until a housing of the functional component was damaged, and running distances were measured. Evaluation results are expressed as index values with Conventional Example 1 being assigned the index value of 100. Larger index values indicate superior high-speed durability.

### Removability (Functional Component):

For the housing body with a functional component of each test tire, the operation of removing the functional component inserted into the housing body was repeated 10 times, and the time required for each removing operation was measured. The evaluation results are indicated in three stages: “⊚ (excellent)” when the required time for each of the 10 times operations was within 20 seconds, “∘ (good)” when the required time for each of the 10 times operations was more than 20 seconds and within 60 seconds, and “x (poor)” when the required time for each of the 10 times operations was more than 60 seconds.

### Cracking Resistance (Housing Body):

Each of the test tires was mounted on a wheel having a rim size of 18×7½JJ, an 80% load of the maximum load capacity was applied after deterioration treatment was performed in the presence of oxygen at 80° C. for five days, and a running test was performed on the tire using a drum testing machine under the condition of air pressure of 250 kPa. Specifically, the speed was increased from an initial speed of 120 km/h by 10 km/h every 24 hours, the tires were run until the speed reached 170 km/h, and then the occurrence of cracks or wrinkles in the housing body was visually confirmed. The evaluation results were indicated in three levels: “⊚ (excellent)” when there were no cracks and wrinkles, “∘ (good)” when there were only wrinkles, and “x (poor)” when there were cracks.

### Durability (Housing Body):

Each of the test tires was mounted on a wheel having a rim size of 18×7½JJ, and a running test was performed on the tire using a drum testing machine at air pressure of 540 kPa, 160% with respect to the maximum load, running speed of 81 km/h, and a running distance of 20000 km. Thereafter, the occurrence of damage of the housing body and cracks therein was visually confirmed, and the total number of occurrence locations was measured. The evaluation results are expressed as index values using the reciprocal of the measurement values, with Conventional Example 1 being assigned the index value of 100. Larger index values indicate superior durability.

TABLE 1-1

| | | Conven- | Conven- | | |
|---|---|---|---|---|---|
| | | tional | tional | | |
| | | Exam- | Exam- | Exam- | Exam- |
| | | ple 1 | ple 2 | ple 1 | ple 2 |
| Ratio D2ᵤ/D1ᵤ | | 0.50 | 1.00 | 0.60 | 0.95 |
| Magnitude relationship | | Larger | Larger | Larger | Larger |
| between ratio D2ᵤ/D1ᵤ and | | | | | |
| ratio D2_{L}/D1_{L} | | | | | |
| Ratio H2/H1 | | 0.75 | 0.75 | 0.75 | 0.75 |
| Ratio D2_{◯}/D1ᵤ | | 0.25 | 0.25 | 0.25 | 0.25 |
| Ratio Sc/Ss | | 0.4 | 0.4 | 0.4 | 0.4 |
| Inclination angle θ2 of | | 83° | 83° | 83° | 83° |
| crown portion after housing | | | | | |
| Functional | High-speed | 100 | 90 | 102 | 102 |
| component | durability | | | | |
| | Removability | ◯ | ◯ | ◯ | ◯ |
| Housing | Cracking | X | ◯ | ◯ | ◯ |
| body | resistance | | | | |
| | Durability | 100 | 101 | 101 | 101 |

TABLE 1-2

| | | Example | Example | Example | Example | Example |
|---|---|---|---|---|---|---|
| | | 3 | 4 | 5 | 6 | 7 |
| Ratio D2ᵤ/D1ᵤ | | 0.80 | 0.80 | 0.80 | 0.80 | 0.80 |
| Magnitude relationship between | | Larger | Equivalent | Smaller | Smaller | Smaller |
| ratio D2ᵤ/D1ᵤ and ratio D2_{L}/D1_{L} | | | | | | |
| Ratio H2/H1 | | 0.75 | 0.75 | 0.75 | 0.80 | 0.85 |
| Ratio D2_{O}/D1ᵤ | | 0.25 | 0.25 | 0.25 | 0.25 | 0.25 |
| Ratio Sc/Ss | | 0.4 | 0.4 | 0.4 | 0.4 | 0.4 |
| Inclination angle θ2 of crown | | 83° | 83° | 83° | 83° | 83° |
| portion after housing | | | | | | |
| Functional | High-speed durability | 102 | 102 | 102 | 104 | 108 |
| component | Removability | ◯ | ◯ | ◯ | ◯ | ◯ |
| Housing body | Cracking resistance | ◯ | ◯ | ◯ | ◯ | ◯ |
| | Durability | 101 | 103 | 103 | 103 | 103 |

TABLE 1-3

| | | Exam- | Exam- | Exam- | Exam- |
|---|---|---|---|---|---|
| | | ple 8 | ple 9 | ple 10 | ple 11 |
| Ratio D2ᵤ/D1ᵤ | | 0.80 | 0.80 | 0.80 | 0.80 |
| Magnitude relationship | | Smaller | Smaller | Smaller | Smaller |
| between ratio D2ᵤ/D1ᵤ and | | | | | |
| ratio D2_{L}/D1_{L} | | | | | |
| Ratio H2/H1 | | 0.98 | 1.00 | 0.90 | 0.90 |
| Ratio D2_{◯}/D1ᵤ | | 0.25 | 0.25 | 0.3 | 0.4 |
| Ratio Sc/Ss | | 0.4 | 0.4 | 0.4 | 0.4 |
| Inclination angle θ2 of | | 83° | 83° | 83° | 83° |
| crown portion after housing | | | | | |
| Functional | High-speed | 108 | 104 | 112 | 112 |
| component | durability | | | | |
| | Removability | ◯ | ◯ | ◯ | ⊚ |
| Housing | Cracking | ◯ | ◯ | ◯ | ◯ |
| body | resistance | | | | |
| | Durability | 103 | 103 | 103 | 103 |

TABLE 2-1

| | | Example | Example | Example | Example | Example |
|---|---|---|---|---|---|---|
| | | 12 | 13 | 14 | 15 | 16 |
| Ratio D2ᵤ/D1ᵤ | | 0.80 | 0.80 | 0.80 | 0.80 | 0.80 |
| Magnitude relationship between | | Smaller | Smaller | Smaller | Smaller | Smaller |
| ratio D2ᵤ/D1ᵤ and ratio D2_{L}/D1_{L} | | | | | | |
| Ratio H2/H1 | | 0.90 | 0.90 | 0.90 | 0.90 | 0.90 |
| Ratio D2_{O}/D1ᵤ | | 0.6 | 0.8 | 0.9 | 0.6 | 0.6 |
| Ratio Sc/Ss | | 0.4 | 0.4 | 0.4 | 0.5 | 0.6 |
| Inclination angle θ2 of crown | | 83° | 83° | 83° | 83° | 83° |
| portion after housing | | | | | | |
| Functional | High-speed durability | 110 | 108 | 104 | 117 | 117 |
| component | Removability | ⊚ | ⊚ | ⊚ | ⊚ | ⊚ |
| Housing | Cracking resistance | ◯ | ◯ | ◯ | ◯ | ⊚ |
| body | Durability | 103 | 103 | 103 | 103 | 103 |

TABLE 2-2

| | | Exam- | Exam- | Exam- | Exam- |
|---|---|---|---|---|---|
| | | ple 17 | ple 18 | ple 19 | ple 20 |
| Ratio D2ᵤ/D1ᵤ | | 0.80 | 0.80 | 0.80 | 0.80 |
| Magnitude relationship | | Smaller | Smaller | Smaller | Smaller |
| between ratio D2ᵤ/D1ᵤ and | | | | | |
| ratio D2_{L}/D1_{L} | | | | | |
| Ratio H2/H1 | | 0.90 | 0.90 | 0.90 | 0.90 |
| Ratio D2_{◯}/D1ᵤ | | 0.6 | 0.6 | 0.6 | 0.6 |
| Ratio Sc/Ss | | 0.8 | 0.9 | 1.0 | 0.8 |
| Inclination angle θ2 of | | 83° | 83° | 83° | 85° |
| crown portion after housing | | | | | |
| Functional | High-speed | 115 | 113 | 110 | 115 |
| component | durability | | | | |
| | Removability | ⊚ | ⊚ | ⊚ | ⊚ |
| Housing | Cracking | ⊚ | ⊚ | ⊚ | ⊚ |
| body | resistance | | | | |
| | Durability | 103 | 103 | 103 | 103 |

TABLE 2-3

| | | Exam- | Exam- | Exam- | Exam- |
|---|---|---|---|---|---|
| | | ple 21 | ple 22 | ple 23 | ple 24 |
| Ratio D2ᵤ/D1ᵤ | | 0.80 | 0.80 | 0.80 | 0.80 |
| Magnitude relationship | | Smaller | Smaller | Smaller | Smaller |
| between ratio D2ᵤ/D1ᵤ and | | | | | |
| ratio D2_{L}/D1_{L} | | | | | |
| Ratio H2/H1 | | 0.90 | 0.90 | 0.90 | 0.90 |
| Ratio D2_{◯}/D1ᵤ | | 0.6 | 0.6 | 0.6 | 0.6 |
| Ratio Sc/Ss | | 0.8 | 0.8 | 0.8 | 0.8 |
| Inclination angle θ2 of | | 90° | 95° | 115° | 120° |
| crown portion after housing | | | | | |
| Functional | High-speed | 115 | 115 | 115 | 115 |
| component | durability | | | | |
| | Removability | ⊚ | ⊚ | ⊚ | ⊚ |
| Housing | Cracking | ⊚ | ⊚ | ⊚ | ⊚ |
| body | resistance | | | | |
| | Durability | 105 | 105 | 105 | 103 |

As can be seen from Tables 1 and 2, the pneumatic tires of Examples 1 to 24 have improved high-speed durability of the functional component and cracking resistance of the housing body as compared to those of Conventional Example 1. In particular, the pneumatic tires of Examples 11 to 24 have improved removability of the functional component as compared to that of Conventional Example 1. The pneumatic tires of Examples 1 to 24 have improved durability of the housing body as compared to that of Conventional Example 1.

On the other hand, in Conventional Example 2, since the ratio D2₁₁/D1ᵤ was set to be larger than the numerical value defined in the present technology, the restricting force by the housing body decreased, and the motion of the functional component in the housing body increased. As a result, high-speed durability was deteriorated.

1. A housing body with a functional component, the housing body comprising:
a functional component configured to acquire tire information; and
a housing body housing the functional component;
the housing body comprising a bottom portion fixed to a tire inner surface, a crown portion protruding from the bottom portion, a housing space formed by the bottom portion and the crown portion, and an opening portion communicating with the housing space,
the opening portion having a width smaller than a minimum width of the housing space, and
a circumferential length D2ᵤ of an upper portion of the housing space and a circumferential length D1ᵤ of an upper portion of the functional component satisfying a relationship 0.60≤D2ᵤ/D1ᵤ≤0.95.

2. The housing body with a functional component according to claim 1, wherein a ratio D2ᵤ/D1ᵤ of the circumferential length D2ᵤ of the upper portion of the housing space to the circumferential length D1ᵤ of the upper portion of the functional component is equivalent to or smaller than a ratio D2_{L}/D1_{L} of a circumferential length D2_{L} of a lower portion of the housing space to a circumferential length D1_{L} of a lower portion of the functional component.

3. The housing body with a functional component according to claim 1, wherein
an end portion of the crown portion comprises a locking portion bent toward the opening portion, and
a height H1 of the functional component and a total inner height H2 of the housing body satisfy a relationship 0.85≤H2/H1≤0.98.

4. The housing body with a functional component according to claim 1, wherein a circumferential length D2_{O} of the opening portion of the housing body and the circumferential length D1ᵤ of the upper portion of the functional component satisfy a relationship 0.4≤D2_{O}/D1ᵤ≤0.8.

5. The housing body with a functional component according to claim 1, wherein a sum Sc of cross-sectional areas of the housing space and the opening portion in a state where the functional component is not housed in the housing space and a cross-sectional area Ss of the functional component in the sum Sc of the cross-sectional areas of the housing space and the opening portion satisfy a relationship 0.6≤Sc/Ss≤0.9.

6. The housing body with a functional component according to claim 1, wherein an inclination angle of the crown portion measured on an outer wall side of the crown portion in a state where the functional component is housed in the housing space with respect to the bottom portion ranges from 90° to 115°.

7. The housing body with a functional component according to claim 1, wherein
a modulus of the housing body at 100% elongation at 20° C. is 0.5 MPa or more and less than 10.0 MPa, and
a loss modulus of the housing body at 60° C. is 0.4 MPa or more and less than 20.0 MPa.

8. The housing body with a functional component according to claim 1, wherein the housing body is made of vulcanized rubber.

9. The housing body with a functional component according to claim 1, wherein the housing body is fixed to the tire inner surface with an adhesive.

10. A tire, comprising
the housing body with a functional component according to claim 1 fixed to the tire inner surface,
the functional component being housed in the housing space.

11. The housing body with a functional component according to claim 2, wherein
an end portion of the crown portion comprises a locking portion bent toward the opening portion, and
a height H1 of the functional component and a total inner height H2 of the housing body satisfy a relationship 0.85≤H2/H1≤0.98.

12. The housing body with a functional component according to claim 11, wherein a circumferential length D2_{O} of the opening portion of the housing body and the circumferential length D1ᵤ of the upper portion of the functional component satisfy a relationship 0.4≤D2_{O}/D1ᵤ≤0.8.

13. The housing body with a functional component according to claim 12, wherein a sum Sc of cross-sectional areas of the housing space and the opening portion in a state where the functional component is not housed in the housing space and a cross-sectional area Ss of the functional component in the sum Sc of the cross-sectional areas of the housing space and the opening portion satisfy a relationship 0.6≤Sc/Ss≤0.9.

14. The housing body with a functional component according to claim 13, wherein an inclination angle of the crown portion measured on an outer wall side of the crown portion in a state where the functional component is housed in the housing space with respect to the bottom portion ranges from 90° to 115°.

15. The housing body with a functional component according to claim 14, wherein
a modulus of the housing body at 100% elongation at 20° C. is 0.5 MPa or more and less than 10.0 MPa, and
a loss modulus of the housing body at 60° C. is 0.4 MPa or more and less than 20.0 MPa.

16. The housing body with a functional component according to claim 15, wherein the housing body is made of vulcanized rubber.

17. The housing body with a functional component according to claim 16, wherein the housing body is fixed to the tire inner surface with an adhesive.

18. A tire, comprising
the housing body with a functional component according to claim 17 fixed to the tire inner surface,
the functional component being housed in the housing space.
